(19) United States
(12) Patent Application Publication
(10) Pub. No.: US 2018/0039099 A1
(43) Pub. Date: Feb. 8, 2018

(54) PIECE OF OPHTHALMIC EQUIPMENT; METHOD FOR SUPPLYING A PIECE OF OPHTHALMIC EQUIPMENT WITH POWER

(71) Applicant: Essilor International (Compagnie Générale d'Optique), Charenton-le-Pont (FR)

(72) Inventors: Stéphane PERROT, Charenton-le-Pont (FR); David ESCAICH, Charenton-le-Pont (FR); Jérôme BALLET, Charenton-le-Pont (FR); Aude BOUCHIER, Charenton-le-Pont (FR); Willy CHAUDAT, Charenton-le-Pont (FR); Samuel ARCHAMBEAU, Charenton-le-Pont (FR)

(21) Appl. No.: 15/671,915

(22) Filed: Aug. 8, 2017

(30) Foreign Application Priority Data
Aug. 8, 2016 (EP) 16306031.2

(51) Int. Cl. G02C 11/00; H01F 27/28

(52) U.S. Cl. CPC G02C 11/10; H01F 27/28

(57) ABSTRACT

Piece of ophthalmic equipment comprising a frame (30), at least one ophthalmic lens (10), wherein the frame and/or the ophthalmic lens comprises a conductive material arranged, on the periphery of the external outline of the ophthalmic lens, in the form of at least one substantially closed turn (20), so as to form a supply inductor allowing the electronic component to be supplied with electrical power via mutual inductance with a source magnetic circuit that has an inductance.

The present invention relates to a piece of ophthalmic equipment. The present invention more particularly relates to a piece of ophthalmic equipment comprising a frame, at least one ophthalmic lens having an external outline and arranged in the frame, and at least one electronic component. The present invention also relates to a method for supplying the supply inductor of a piece of ophthalmic equipment with power.

Pieces of ophthalmic equipment comprising at least one electronic component are known in the prior art. The electronic component(s) is (are) in general intended to contribute to the control of an electrically controlled function of an ophthalmic lens. By way of example, mention may be made of the following electrically controlled functions: a function allowing transmittance to be varied, for example electrochromically, a function allowing information to be displayed, and a function allowing the lens to be moved or oriented. Such pieces of equipment are commonly called “active pieces of ophthalmic equipment” or also, for the sake of succinctness, “active lenses”. The electrically controlled functions may be actuated by a passive component, for example a resistive component, a capacitive component or an inductive component, and/or by an active component, for example a battery, a diode, a sensor, a radio component, an imaging device, a microprocessor or an actuator. Such components must be supplied with an electrical current. It is often tricky to supply a component with an electrical current and it in general requires a wired connection that may pose problems in terms of bulk and/or reliability.

The present invention proposes to solve the resulting technical problem and consists in simplifying and making more reliable the supply of an electrical current to a component of a piece of ophthalmic equipment, in particular with a technical solution that is simple to implement, and which preferably has no impact or not a large impact on the appearance of the piece of equipment, and while not disrupting the vision of the wearer of the piece of equipment.

To this end, the present invention relates to a piece of ophthalmic equipment comprising a frame, at least one ophthalmic lens having an external outline and arranged in the frame, and at least one electronic component, wherein the frame and/or the ophthalmic lens(es) comprises (comprise) a conductive material arranged, on the periphery of the external outline of the ophthalmic lens, in the form of at least one substantially closed turn, so as to form a supply inductor allowing the electronic component to be supplied with electrical power, and wherein the supply inductor is supplied with power via mutual inductance with a source magnetic circuit that has an inductance.

Such a piece of ophthalmic equipment allows a component of this piece of ophthalmic equipment to be supplied with an electrical current while decreasing the number of, or even eliminating, wired connections. Advantages in terms of connectional simplicity, bulk and reliability result. Furthermore, arranging the conductive material on the periphery of the external outline of the ophthalmic lens allows the turn(s) to be placed discreetly and the visual field of a wearer not to be significantly disrupted, or indeed degraded at all.

The expression “ophthalmic lens” is understood to mean any lens of a nature to be arranged in a frame; such an ophthalmic lens may be an ophthalmic lens suitable for correcting the sight of a wearer, an ophthalmic lens allowing a variable transmittance to be offered to a wearer, and/or an ophthalmic lens of a nature to present information to a wearer. The ophthalmic lens may comprise one or more electronic components. If the ophthalmic lens contains no electronic component, at least one electronic component is arranged on or in the frame of the piece of ophthalmic equipment. Electronic components may be arranged both on or in the frame of the piece of ophthalmic equipment and on or in the ophthalmic lens.

The term “frame” is understood to mean a spectacle frame, such as for example presented in standard ISO 8624:2011 (Ophthalmic optics—Spectacle frames—Measuring system and terminology). Such a frame comprises means for maintaining one, and in general two, ophthalmic lens(es) in front of the eyes of a wearer. Each ophthalmic lens is placed inside a rectangular “box” that circumscribes the shape of the ophthalmic lens. A frame in general comprises temples that are intended to rest on the ears of the wearer. The ophthalmic lenses are connected to the temples by way of a “rim” or are drilled and fastened directly to the temples. In the case of a “conventional” or “full-rimmed” frame, the rim is continuous and completely encircles the lens; in the case of a “Nylor” frame, the rim does not completely encircle the ophthalmic lens, which is retained by a thread, one made of nylon for example.

The expression a “substantially closed turn” is understood to mean a turn the two ends of which are close together and of a nature to allow mutual inductance with a source magnetic circuit that has an inductance; according to one embodiment, the two ends of the turn are separated by less than 1 cm, or even by less than 5 mm; according to one embodiment, the angle between the two ends of the turn is less than 10°, or even less than 5°, considering the angle between two straight lines passing through these ends and through the centroid of the outline of the turn.

The expression “mutual inductance” is understood to mean a variation in current in a magnetic circuit that leads to the appearance of a voltage in another magnetic circuit. Mention is made, by way of example of methods allowing mutual inductance to be achieved, of wireless power transmission methods according to the “Qi” protocol developed by the Wireless Power Consortium. A “Qi system” comprises a charging pad (a charger) and a compatible receiver in a mobile device. To use this system, the mobile device is placed on the charging pad, which then recharges it via magnetic inductance. Power may be transmitted wirelessly over a distance of as large as 40 mm. The transmitted powers may be low, from 0 to 5 W, or intermediate, up to 120 W. For the present invention, the mobile device is the piece of ophthalmic equipment.

Generally, the smallest inside dimension of the outline of the turn(s) is larger than or equal to 1 cm and preferably larger than or equal to 3 cm; according to one embodiment, a circle of 3 cm may be inscribed inside the outline of the turn(s). This results in highly effective loading of the supply inductor with a source magnetic circuit that has a inductance.

The present invention also relates to a piece of ophthalmic equipment furthermore comprising the features of the following embodiments, which embodiments may be combined together in any technically envisageable solution:
the conductive material is arranged in the form of a plurality of closed turns that are arranged on the periphery of the external outline of the ophthalmic lens; according to another embodiment, the conductive material is arranged in the form of one substantially closed turn that is arranged on the periphery of the external outline of the ophthalmic lens;
the turns of the supply inductor are insulated from one another, contiguous and substantially concentric; the number of turns of the supply inductor is lower than or equal to 50 and for example is comprised between 5 and 20 turns;
the turn(s) has (have) a cross section the smallest dimension and the largest dimension of which are larger than or equal to 10 μm and smaller than or equal to 200 μm, the cross section for example having a diameter larger than or equal to 10 μm and smaller than or equal to 200 μm;
the conductive material is chosen from a material taking the form of a wire or of a layer, a material resulting from the deposition of a conductive ink, a material resulting from chemical etching, a material resulting from laser etching a conductive deposit, a material resulting from chemical vapour deposition (CVD), a material resulting from physical vapour deposition (PVD);
the electronic component supplied with power by the supply inductor is a passive component, in particular one chosen from the following list of passive components: a resistive component, a capacitive component and an inductive component, or is an active component, in particular one chosen from the following list of active components: a battery, a diode, a sensor, a radio component, an imaging device, a microprocessor, and an actuator, of a motor for example;
the turn(s) of the supply inductor is (are) configured to form an antenna so as to allow an exchange of data between the piece of ophthalmic equipment and a device for transmitting and/or receiving data;
the frame comprises a continuous rim in which the ophthalmic lens is arranged and wherein the turn(s) of the supply inductor is (are) arranged on and/or in the continuous rim of the frame;
the turn(s) of the supply inductor is (are) arranged peripherally on and/or in the ophthalmic lens; according to one embodiment, the ophthalmic lens comprises a peripheral groove and wherein the turn(s) of the supply inductor is (are) arranged in said peripheral groove; according to one embodiment, the frame comprises a continuous rim in which the ophthalmic lens is arranged, and wherein a conductive material is arranged in the form of at least one substantially closed turn on and/or in the continuous rim of the frame so as to form a source magnetic circuit that has an inductance, said circuit being configured to supply, via mutual inductance, the turn(s) of the supply inductor with power, which turn(s) is (are) arranged peripherally on and/or in the ophthalmic lens.

The present invention also relates to an assembly comprising a piece of ophthalmic equipment such as defined above and a charger comprising a source magnetic circuit that has an inductance, said circuit being configured to supply the supply inductor with power via mutual inductance between the supply inductor and the source magnetic circuit that has an inductance.

The present invention also relates to a method for supplying the supply inductor of a piece of ophthalmic equipment such as defined above with power, which comprises a step of bringing said piece of ophthalmic equipment and a source magnetic circuit that has an inductance close enough to allow mutual inductance between the supply inductor and the source magnetic circuit that has an inductance, then a step of loading the supply inductor with the source magnetic circuit that has an inductance.

The invention will be better understood with reference to the appended drawings, in which:

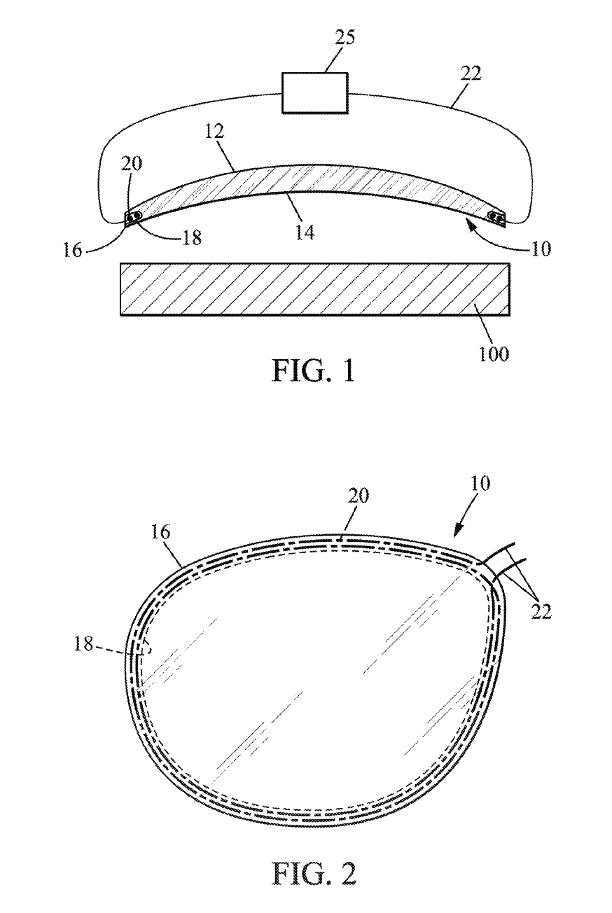

FIGS. 1 and 2 show one embodiment of one portion of a piece of ophthalmic equipment according to the invention;

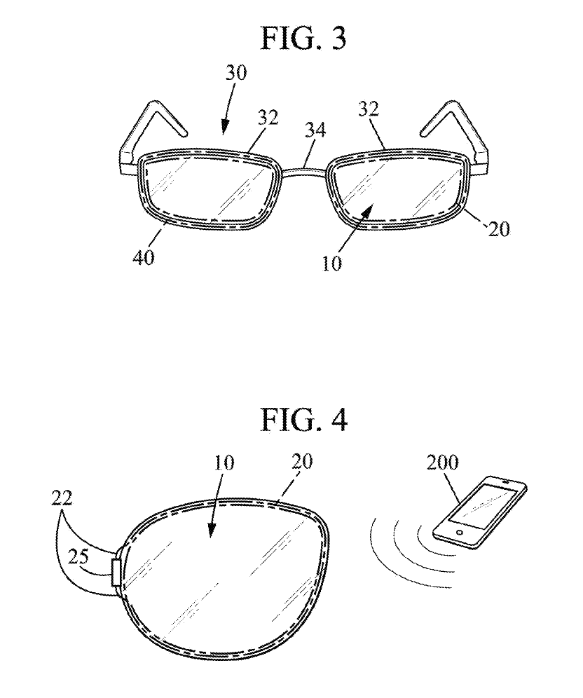

FIG. 3 shows another embodiment of a piece of ophthalmic equipment according to the invention; and

FIG. 4 shows another embodiment of a portion of a piece of ophthalmic equipment according to the invention.

It should be noted that the components of the device shown have not necessarily been drawn to scale and that the figures are solely intended to facilitate comprehension of the present invention. Components shown in more than one figure have been referenced with the same reference number in the various figures.

FIG. 1 shows a schematic cross-section of one embodiment of a portion of an assembly comprising a piece of ophthalmic equipment according to the invention, which comprises an ophthalmic lens 10; FIG. 2 shows a schematic view of this ophthalmic lens 10 from above. The ophthalmic lens 10 has an external outline 16; this ophthalmic lens is arranged in a frame that is not shown. The ophthalmic lens 10 has a convex front face 12 and a concave back face 14. The ophthalmic lens 10 comprises a conductive material that is arranged, on the periphery of the external outline 16 of the ophthalmic lens, in the form of two turns 20; the turn located closest the external outline 16 is substantially closed and that closest the interior is closed. In this embodiment, the ophthalmic lens 10 comprises a peripheral groove 18 and the turns 20 are arranged in said peripheral groove. These turns 20 are insulated from each other, contiguous and substantially concentric. They are connected by a conductor 22, for example a wire, to an electronic component 25. These turns 20 form a supply inductor allowing the electronic component 25 to be supplied with electrical power; this supply inductor is supplied with power via mutual inductance with a source magnetic circuit that has an inductance, said circuit being comprised in the charger 100.

According to one embodiment, the periphery of the external outline of the ophthalmic lens is formed by a zone comprised between the external outline (the external edge) of the ophthalmic lens and a line that is 2 mm away from said external outline, and located radially towards the interior of the ophthalmic lens.

According to one embodiment, the periphery of the external outline of the ophthalmic lens is formed by a zone defined from the edge of the rim of the frame in which the ophthalmic lens is arranged; according to one embodiment, this zone is comprised between this edge of the frame and a line 2 mm away from this edge, and located radially towards the interior of the ophthalmic lens; it is thus possible not to encroach by more than 2 mm on the interior of the useful optical zone, in order to very significantly limit disruption of the vision of the wearer. The useful optical zone is all of the points of the lens that may be scanned by the gaze of the wearer.

According to one embodiment, the conductive material is completely invisible to the wearer, for example when the conductive material is masked by the bezel of the frame. The conductive material may be arranged, on the periphery of the external outline, over most of the outline (in order not to disrupt the vision of the wearer) and preferably over at least 80% of the outline. According to one embodiment, if a portion of the conductive material is not located on the periphery of the outline, this portion is preferably located on the temporal side, in order to limit the impact on the visual field, and does not exceed 20% of the outline.

According to one embodiment, the conductive material is copper. According to one embodiment, the conductive material is a wire, for example covered with an enamel or any insulator (polyurethane varnish for example). According to one embodiment, the conductive material results from the deposition of a conductive ink. According to one embodiment, the conductive material results from chemical etching, for example of the photolithography type. According to one embodiment, the conductive material results from chemical vapour deposition (CVD) or physical vapour deposition (PVD).

FIG. 3 schematically shows another embodiment in which the frame 30 comprises two continuous rims 32 in which ophthalmic lenses 10 are arranged. These continuous rims are connected by a bridge 34. A conductive material is arranged, on the periphery of the external outline of each of the ophthalmic lenses, on and/or in each of the ophthalmic lenses, in the form of at least one substantially closed turn 20, so as to form a supply inductor allowing an electronic component (not shown) to be supplied with electrical power. A conductive material is arranged, in the form of at least one substantially closed turn 40, on or in the rim of the frame, so as to form a source magnetic circuit that has an inductance. This source magnetic circuit that has an inductance is configured to supply the supply inductor with power via mutual inductance with the turns 20. The source magnetic circuit that has an inductance is supplied with power by an electronic component (not shown), for example a battery located on one of the temples of the frame. It is thus possible to supply an electronic device arranged on each ophthalmic lens with power, said electronic device allowing an electrically controlled optical function of each ophthalmic lens to be controlled.

Reciprocally, the ophthalmic lens may be equipped with a means having a power-source function (for example an ophthalmic lens possessing a photovoltaic surface); in this case, the turn 20 may be used by way of source magnetic circuit that has an inductance. The turn 40 on and/or in the rim of the frame may then be supplied with power via mutual inductance with the turn 20, and, according to one embodiment, a battery located in a temple of the frame may then be recharged.

FIG. 4 schematically shows one embodiment in which an ophthalmic lens forming a portion of a piece of ophthalmic equipment according to the present invention, for example corresponding to the embodiment of FIGS. 1 and 2, may exchange information with a device that is external to said piece of ophthalmic equipment. In this case, the turn(s) of the supply inductor is (are) configured to form an antenna so as to allow an exchange of data between the piece of ophthalmic equipment and a device for transmitting and/or receiving data, for example a mobile telephone 200. The ophthalmic lens 10 and the mobile telephone 200 may thus exchange with each other data in a wireless mode by virtue of a communication interface (for example according to a protocol chosen from the following short range telecommunications protocols: Bluetooth, Zigbee, Wi-Fi and ANT).

By virtue of the piece of ophthalmic equipment according to the present invention, it is possible to implement a method for supplying a piece of ophthalmic equipment with power, which comprises a step of bringing said device and a source magnetic circuit that has an inductance close enough to allow mutual inductance between the supply inductor of the piece of ophthalmic equipment and the source magnetic circuit that has an inductance, then a step of loading the supply inductor with the source magnetic circuit that has an inductance.

Of course, the invention is not limited to the embodiments described above, which were given merely by way of example. The invention encompasses various modifications, alternative forms and other variants that those skilled in the art will be able to envisage in the context of the present invention and in particular any combination of the various operating modes described above, which may be implemented separately or in association.

1. A piece of ophthalmic equipment comprising a frame, at least one ophthalmic lens having an external outline and arranged in the frame, and at least one electronic component, wherein at least one of the frame and the ophthalmic lens comprises a conductive material arranged, on the periphery of the external outline of the ophthalmic lens, in a form of at least one substantially closed turn, so as to form a supply inductor allowing the at least one electronic component to be supplied with electrical power, and wherein the supply inductor is supplied with power via mutual inductance with a source magnetic circuit that has an inductance.

2. The piece of ophthalmic equipment according to claim 1, wherein the conductive material is arranged in the form of a plurality of closed turns that are arranged on the periphery of the external outline of the ophthalmic lens.

3. The piece of ophthalmic equipment according to claim 2, wherein turns of the supply inductor are insulated from one another, are contiguous and are substantially concentric.

4. The piece of ophthalmic equipment according to claim 2, wherein a number of turns of the supply inductor is lower than or equal to 50.

5. The piece of ophthalmic equipment according to claim 2, wherein the plurality of closed turns have cross sections the smallest dimension and the largest dimension of which are larger than or equal to 10 μm and smaller than or equal to 200 μm.

6. The piece of ophthalmic equipment according to claim 1, wherein the conductive material is chosen from at least one of a wire, of a layer, a material resulting from the deposition of a conductive ink, a material resulting from chemical etching, a material resulting from laser etching a conductive deposit, a material resulting from chemical vapour deposition, and a material resulting from physical vapour deposition.

7. The piece of ophthalmic equipment according to claim 1, wherein one the at least one electronic component supplied with power by the supply inductor is a passive component, chosen from at least one of a resistive component, a capacitive component and an inductive component, or is an active component, in particular one chosen from the following list of active components: a battery, a diode, a sensor, a radio component, an imaging device, a microprocessor, and an actuator, of a motor.

8. The piece of ophthalmic equipment according to claim 1, wherein turns the turn(s) of the supply inductor are is (are) configured to form an antenna so as to allow an exchange of data between the piece of ophthalmic equipment and a device for at least one of transmitting and receiving data.

9. The piece of ophthalmic equipment according to claim 1, wherein the frame comprises a continuous rim in which the ophthalmic lens is arranged and wherein turns of the supply inductor are at least one of arranged on and in the continuous rim of the frame.

10. The piece of ophthalmic equipment according to claim 1, wherein turns of the supply inductor are at least one of arranged peripherally on and in the ophthalmic lens.

11. The piece of ophthalmic equipment according to claim 10, wherein the ophthalmic lens comprises a peripheral groove and wherein the turns of the supply inductor are arranged in said peripheral groove.

12. The piece of ophthalmic equipment according to claim 10, wherein the frame comprises a continuous rim in which the ophthalmic lens is arranged, and wherein a conductive material is arranged in the form of at least one substantially closed turn on and in the continuous rim of the frame so as to form a source magnetic circuit that has an inductance, said circuit being configured to supply, via mutual inductance, the turns of the supply inductor with power, which the turns are at least one of arranged peripherally on and in the ophthalmic lens.

13. An assembly comprising:
a piece of ophthalmic equipment comprising a frame, at least one ophthalmic lens having an external outline and arranged in the frame, and at least one electronic component, wherein at least one of the frame and the ophthalmic lens comprises a conductive material arranged, on the periphery of the external outline of the ophthalmic lens, in a form of at least one substantially closed turn, so as to form a supply inductor allowing the at least one electronic component to be supplied with electrical power, and wherein the supply inductor is supplied with power via mutual inductance with a source magnetic circuit that has an inductance; and
a charger comprising the source magnetic circuit having an inductance, said source magnetic circuit being configured to supply the supply inductor with power via mutual inductance between the supply inductor and the source magnetic circuit that has an inductance.

14. A method for supplying a supply inductor of a piece of ophthalmic equipment, the method comprising:
a step of bringing said piece of ophthalmic equipment and a source magnetic circuit that has an inductance close enough to allow mutual inductance between the supply inductor and the source magnetic circuit that has an inductance; and
a step of loading the supply inductor with the source magnetic circuit that has the inductance,
wherein the piece of ophthalmic equipment comprises a frame, at least one ophthalmic lens having an external outline and arranged in the frame, and at least one electronic component, wherein at least one of the frame and the ophthalmic lens comprises a conductive material arranged, on the periphery of the external outline of the ophthalmic lens, in a form of at least one substantially closed turn, so as to form the supply inductor allowing the at least one electronic component to be supplied with electrical power, and wherein the supply inductor is supplied with power via the mutual inductance with the source magnetic circuit that has the inductance.

15. The piece of ophthalmic equipment according to claim 3, wherein a number of the turns of the supply inductor is lower than or equal to 50.

16. The piece of ophthalmic equipment according to claim 11, wherein the frame comprises a continuous rim in which the ophthalmic lens is arranged, and wherein a conductive material is arranged in the form of at least one substantially closed turn on and in the continuous rim of the frame so as to form a source magnetic circuit that has an inductance, said circuit being configured to supply, via mutual inductance, the turns of the supply inductor with power, which the turns are at least one of arranged peripherally on and in the ophthalmic lens.

17. The assembly of claim 13, wherein the conductive material is arranged in the form of a plurality of closed turns that are arranged on the periphery of the external outline of the ophthalmic lens.

18. The assembly of claim 17, wherein turns of the supply inductor are insulated from one another, are contiguous and are substantially concentric.

19. The assembly of claim 17, wherein a number of turns of the supply inductor is lower than or equal to 50.

20. The assembly of claim 17, wherein the plurality of the closed turns have cross sections, the smallest dimension and the largest dimension of which are larger than or equal to 10 μm and smaller than or equal to 200 μm.
